(19) United States
(12) Patent Application Publication
(10) Pub. No.: US 2003/0176211 A1
(43) Pub. Date: Sep. 18, 2003

(54) Electronic gaming station

(76) Inventor: Trenton Scott Sommerville, Destin, FL (US)

Correspondence Address: LAW OFFICES OF ERIC KARICH, 2807 ST. MARK DR., MANSFIELD, TX, 76063, US

(21) Appl. No.: 10/236,632

(22) Filed: Sep. 5, 2002

Related U.S. Application Data
(60) Provisional application No. 60/364,793, filed on Mar. 15, 2002.
(60) Provisional application No. 60/373,369, filed on Apr. 16, 2002.

(51) Int. Cl. G06F 17/00

(52) U.S. Cl. 463/16

(57) ABSTRACT

An electronic gaming station with 3D advertising has an advertising display screen for providing an advertisement image, and an advertisement lens operably spaced apart from the advertising display screen for projecting the advertisement image beyond the advertisement lens to form a projected advertisement image. The advertising display screen is operatively connected for receiving the advertisement image from a video source, preferably through a computer. The computer is adapted to operating a game of chance. The electronic gaming station also includes a game display screen that is operably engaged with the computer for projecting output images of the game of chance.

### CROSS-REFERENCE TO RELATED APPLICATIONS

This application for a utility patent claims the benefit of the U.S. Provisional Application titled ELECTRONIC GAMBLING APPARATUS, application No. 60/364,793, filed Mar. 15, 2002, and the U.S. Provisional Application titled ELECTRONIC SLOT MACHINE, application No. 60/373,369, filed Apr. 16, 2002. Each of these related applications is incorporated herein by reference in its entirety.

### STATEMENT REGARDING FEDERALLY SPONSORED RESEARCH

Not Applicable

### BACKGROUND OF THE INVENTION

1. Field of the Invention

This invention relates generally to amusement and gaming machines, and more particularly to an electronic gaming station having 3-D advertisements.

2. Description of Related Art

Various electronic gambling devices are well known in the art. Various examples of the prior art include the following:

Raven et al., U.S. Pat. No. 5,429,361, teaches a gaming machine information and communication system that permits communication between gaming machines and a central control system and between a player operator and a central control system. The system includes a central data processor, a control unit for each gaming machine within the system which is in communication with the central data processor and a player interface which includes a keypad, a card reader and a display. A player interface is secured to each gaming machine and operatively connected to the control unit. The keypad can be used by the player to transmit information to the central data processor. The control unit can be used to identify special players and transmits messages, including promotional messages, for display. The control unit includes memory which contains personality data for the gaming machine and can be used to transmit the personality data from the player interface to its memory. The control unit can accept personality data from a card inserted into the card reader and can be enabled by a personal identification number entered on the keypad. The system provides multiple features including automated maintenance, game accounting, security, player tracking, event tracking, employee/player interaction from the game to the central data processor, cashless operation of gaming machines, reserving gaming machines and other functions.

Walker et al., U.S. Pat. No. 6,390,917, teaches a slot machine advertising machine that enables the user to purchase goods from an account on the machine from his or her gambling winnings. A network server provides control functions for a plurality of the gambling devices. The gambling device includes an interactive display device for displaying messages to the player and for receiving player responses which are then transmitted to a network server. Memory at the network server stores product and product purchase information and customer profile data. The network server causes transmission of product and product purchase information to the interactive display device and monitors each of the gambling devices to detect an occurrence of a player win that requires a monetary payout. The network server is responsive to the detection of the player win and to an entry from the player which indicates the purchase of a product (as offered by a locally displayed advertisement), to credit the purchase price of the product against the anticipated monetary payout. The network server is also controlled to display selected subsets of product and product purchase information in accord with player characteristic data that is input by the player at the gambling device.

Walker et al., U.S. Pat. No. 6,227,972, teaches a casino card that includes a monetary amount for use in a gaming apparatus, the card not being activated until the user meets a specified “player requirement.” The casino card may be utilized to provide payment for slot machine play or other gambling activities for a period of time, and then the casino card expires. The disclosed expiring prepaid casino card is preferably a pointer to a monetary amount stored in a casino prepaid card database, that expires in predefined expiration amounts over each of a plurality of predefined expiration periods. If a player does not utilize the entire predefined expiration amount, for a given predefined expiration period, the remaining balance on the expiring prepaid casino card allocated for the expiration period automatically expires and does not roll over into any subsequent expiration periods. The expiring prepaid casino card may alternatively be embodied as a smart card or a general-purpose debit card programmed with the predefined expiration amounts for each predefined expiration period, or a cardless electronic key or personal identification number (PIN) which may be utilized to access data records which have been programmed with the predefined expiration amounts for each predefined expiration period. The expiring prepaid casino card can preferably be (i) purchased by the player at face value, or at a discount; (ii) given out by the casino to a player for free as part of a promotion, or to preferred players; or (iii) issued to a player as part of a payout on a slot machine. In this manner, the player is incented to make return visits to a casino to access each predefined expiration amount for each predefined expiration period. The predefined expiration amounts and expiration periods do not have to be fixed units. Slot machine jackpots can be awarded in the form of an increased total balance on the expiring prepaid casino card that expire in predefined expiration amounts over predefined expiration periods. The expiring prepaid casino card can preferably be programmed with one or more further restrictions or requirements that the player must satisfy before any expiration amounts can be accessed.

Jorasch et al., U.S. Pat. No. 6,379,248, teaches a gaming device that includes a plurality of balances. By providing different gambling odds for the various balances, the user is encouraged to use certain accounts in preference to others. The gaming device receives monetary input such as currency or a transfer from an account, and in turn increases one or more balances. The balance increased depends on criteria such as the amount of monetary input or the source (e.g. from a casino account). Players may draw wager amounts from different balances, and add award amounts to the balances. Incentives are provided for using the different balances.

Hedrick et al., U.S. Pat. No. 6,368,216, teaches a gaming machine having both main and secondary displays. The main display is controlled electronically by a gaming machine controller, which main display presents the results of a play on the gaming machine. In the case of a slot machine, the main display may be the glass display through which the spinning reels of a game play are viewed. In a video poker gaming machine, the main display is usually a cathode ray tube (“CRT”) which displays a video game image to the player and other information directly associated with the game play. The secondary display is disposed apart from the primary display and is used for presenting primary, secondary, or even tertiary information. The secondary display may be provided at various locations on the gaming machine such as in a top glass portion of the gaming machine or a belly glass portion of the gaming machine, which belly glass portion is located below a main display portion of the gaming machine. The secondary display itself may be a liquid crystal display, a cathode ray tube, a field emission display, a plasma display, a digital micromirror device (DMD), etc.

Dickinson, U.S. Pat. No. 6,210,279, teaches a gaming machine that includes a touch screen for controlling the gaming machine.

Rowe, U.S. Pub. No. 2002/0002075, teaches a gaming apparatus for facilitating monetary and reward transactions and accounting. The apparatus is attached to a server, along with a plurality of the gaming apparatuses, for transmitting game information to a remote game play tracking station. The gaming apparatus preferably includes the use of gaming cards to track the various users of the system.

Strisower, U.S. Pat. No. 5,809,482, teaches a gaming system that is adapted to use gaming cards for the purpose of tracking player gambling transactions. The system includes a casino database the stores betting summary records for each of a plurality players, where each betting summary record is associated with a player identification code, and includes the player's betting rating. One or more gaming tables have a plurality of player positions and a plurality of code readers. A code reader initiates a betting session in response to reading a player identification card encoded with a player identification code. A communications network couples the casino database and gaming table to an automatic tracking and management unit (ATMU). The ATMU has a display unit, and is coupled to the code readers at the gaming table to receive a player identification code for a player at the initiation of a betting session. The ATMU retrieves from the casino database the betting summary record of the player, and displays it to pit personnel at the gaming table on the display unit. The ATMU also collects real time data of the player's betting transactions, including the player's identification code, and an average bet by the player during the betting session. The ATMU updates the betting summary record with the collected real time data for the player, and provides the updated betting summary record to the casino database via the communications network.

Martin, U.S. Pat. No. 5,618,232, teaches a dual mode gaming device system that operates in either gaming or gambling mode, preferably in response to a GPS system that will inform the system when it is legal to operate in gambling mode.

Bell et al., U.S. Pat. No. 5,919,091, teaches a gaming system that can play in either cash or cashless modes. The system can accept cash and operate in a cash mode; and the system can also be connected to a server and operate from an account.

Projection devices are known in the art that project images so that they appear to float in the air. The two most common methods of producing floating objects has been by either reflecting an object from one or more curved mirrors (i.e., parabolic) or viewing an object properly positioned behind one or more lenses. These methodologies are termed reflective or transmissive spatial object devices, respectively.

One means of providing a background image spatial object display is taught by Monroe (U.S. Pat. No. 5,257,130). In this disclosure, a scrim is used to permit a spatial object (produced by either reflective or transmissive means) to appear in front of the scrim (the optical rays forming the object having passed through the open mesh weave of the scrim). The scrim simultaneously serves as a front projection screen surface on which the background image can be projected.

Another means of providing a background image spatial object display is taught by Warren et al. (U.S. Pat No. 5,311,357). Warren discloses the use of two concave mirrors to produce a spatial object with one of the concave mirrors being partially transparent. Behind this partially transparent mirror is an image display which can be readily seen by an observer through the partially transparent concave mirror. Although this device does provide a spatial object floating before a background image, it suffers from several disadvantages. First, the partially transparent concave mirror is an excessively expensive custom optical component. Second, the curve of the partially transparent concave mirror visibly distorts the background image. Third, the background image, on a large screen display, is positioned far back into the device, creating the awkward necessity of peering into a black box. Finally, this device does not provide a means to enhance the 3-D appearance of the background image so that the background image always appears flat.

Still another background image spatial object display is taught by Noble (U.S. Pat. No. 4,671,625). This transmissive spatial object display utilizes a combination of convex lenses with improved viewing of the spatial object provided by a visible reference around the area in which he spatial object appears to serve as a visual cue for the observer. This visible reference is taught primarily as the edge of a box (i.e., shroud) that extends out from the closest convex lens to the observer. A background image is provided by reflecting the spatial object off a partially transparent mirror with the image behind in an optical arrangement similar to Warren, except that this partially transparent mirror is flat and is not used to create the spatial object. In Noble, the transmissive spatial object is created by a transmissive spatial object image produced by a transmissive object display (i.e., CRT). A first convex lens and a second convex lens manipulate the light rays to produce the transmissive spatial object. The transmissive spatial object is viewed from as the reflection of a partially transparent mirror. This mirror folds the beam of the transmissive spatial object and allows a background image (i.e., a poster or full motion display) to appear behind the partially transparent plane that enables the observer to comprehend the spatial position of the transmissive spatial object. As a result, the transmissive spatial object appears to float within the housing.

Machtig et al. U.S. Pat. No. 5,782,547 describes an improved transmissive spatial object display that provides a background image that appears to observers to have 3-D depth and includes the added advantages of permitting several viewers to observe the display simultaneously so that the background image appears on an accessible screen like that of televisions and computer monitors. The background image display is observed directly through a first Fresnel lens of a two Fresnel lens transmissive spatial object display which lens magnifies the background image display and also provides the front screen of the device. A first partially transparent mirror at 45 degrees separates the two Fresnel lenses permitting the background image display to be viewed solely through the first Fresnel lens. The first Fresnel lens serves the dual function of creating a first spatial object (in combination with the second Fresnel lens) and magnifying the background image. The magnified background image appears through the first Fresnel lens creating a pseudo 3-D appearance even though the background image is generated by a 2-dimensional display such as a CRT. Additional embodiments are configured without the second Fresnel lens so that the first Fresnel lens serves to magnify the background display's image and by itself creates the first spatial object.

Finally, Geranio, U.S. Pat. No. 5,993,005, teaches a video wall that has a plurality of spatial object image display devices, each spatial object image display device including a luminous display screen for providing a first image. The luminous display screen is operably engaged with a video wall computer which is operatively engaged with at least one video input device such as a video cassette recorder (VCR). The video wall computer acts as a splitter to distribute the output of the VCR to the plurality of spatial object image display devices. Each spatial object image display device also includes a lens operatively spaced apart from the luminous display screen for projecting the first image beyond the lens to appear as a first spatial object. The luminous display screen and the lens of each spatial object image display device are mounted within a housing that surrounds the luminous display screen and the lens, excluding substantially all light from within the housing, except through an aperture in the housing. The lens is operably mounted in proximity to and substantially covering the aperture, operably positioning the lens to project the first spatial object from the housing. The housing further includes a shroud extending from the perimeter of the aperture far enough to shield the lens, but not far enough to surround the first spatial object. All of the spatial object image display devices are covered with a semitransparent screen, and projector is positioned to project a second image onto the semitransparent screen, thereby forming a complex series of images that appear to be three-dimensional.

The above-described references are hereby incorporated by reference in full.

The prior art teaches various gambling devices. However, the prior art does not teach a gambling device that includes a 3-D advertisement. The present invention fulfills these needs and provides further related advantages as described in the following summary.

### SUMMARY OF THE INVENTION

The present invention teaches certain benefits in construction and use which give rise to the objectives described below.

The present invention provides an electronic gaming station with 3D advertising. The electronic gaming station has an advertising display screen for providing an advertisement image, and an advertisement lens operably spaced apart from the advertising display screen for projecting the advertisement image beyond the advertisement lens to form a projected advertisement image. The advertising display screen is operatively connected for receiving the advertisement image from a video source, preferably through a computer. The electronic gaming station includes a computer that is adapted to operating a game of chance. The electronic gaming station also includes a game display screen that is operably engaged with the computer for projecting output images of the game of chance. The electronic gaming station further includes a housing for containing the computer, the housing having an advertisement aperture across which is mounted the advertisement lens and through which the projected advertisement image is projected.

A primary objective of the present invention is to provide an electronic gaming station having advantages not taught by the prior art.

Another objective is to provide an electronic gaming station that includes a 3-D advertising capability.

A further objective is to provide an electronic gaming station that can be utilized as part of a 3-D gambling network.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a block diagram illustrating a plurality of gaming stations connected via a network to a server;

FIG. 2 is a block diagram of a first embodiment of the gaming station wherein the gaming station is a slot machine;

FIG. 3 is a perspective view thereof;

FIG. 4 is a perspective view thereof showing a portion of the slot machine broken away to reveal a display screen and three advertising display screens;

FIG. 5 is a perspective view of the display screen and the display lens used to project a plurality of projected pay line images;

FIG. 6 is a perspective view of an alternative view thereof;

FIG. 7 is a perspective view of a second embodiment of the gaming station wherein the gaming station is an electronic blackjack machine;

FIG. 8 is a perspective view thereof wherein the top of the gaming station has been broken away to show the inside of the gaming station; and

FIG. 9 is a block diagram thereof.

### DETAILED DESCRIPTION OF THE INVENTION

The above-described drawing figures illustrate the invention, an electronic gaming station 10 with 3D advertising.

Electronic Gaming Station

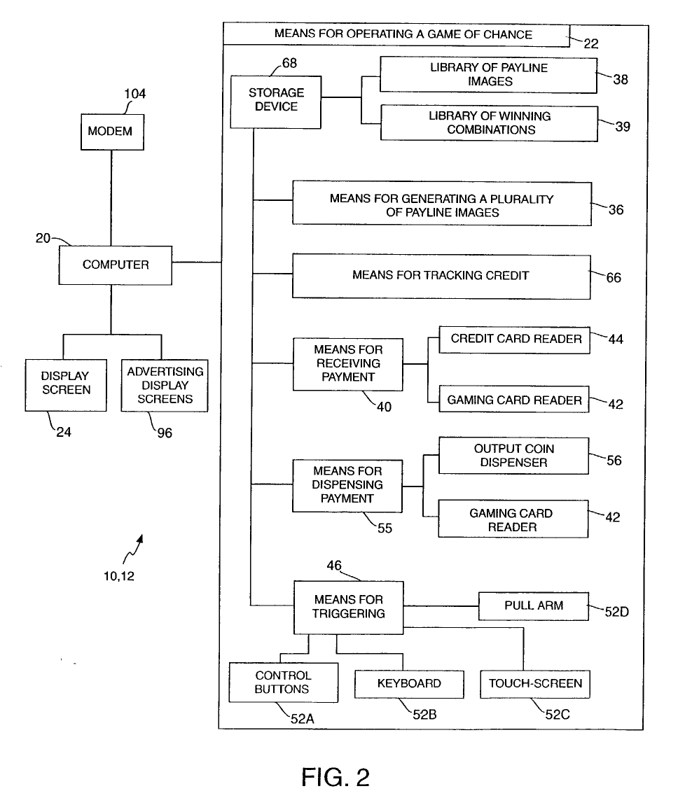

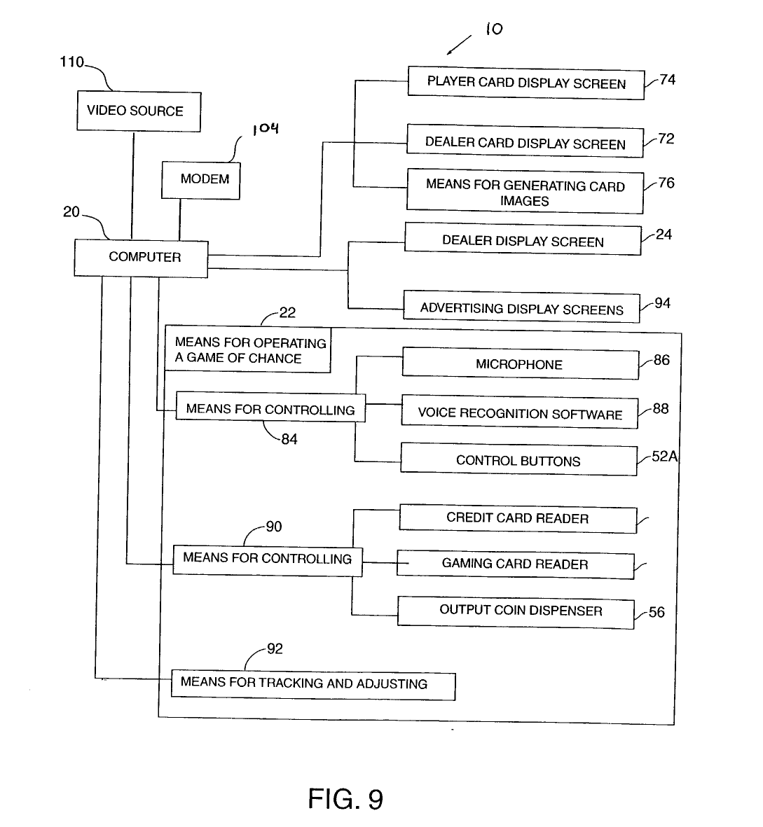

As shown in FIGS. 2 and 9, the electronic gaming station 10 includes a computer 20 that has a means for operating a game of chance 22. The computer 20 is operably attached to a video source 110 and a display screen 24 for projecting output images 28 of the game of chance. In the preferred embodiment, the electronic gaming station 10 further includes a display lens 26 mounted across a display aperture 34 of the housing 32 and operably spaced in front of the display screen 24 for projecting the output images 28 of the game of chance to form projected output images 30 in front of the gaming station 10.

The computer 20 of the gaming station 10 contains the logic for performing operations associated with executing plays on the gaming machine, interacting with players of the gaming station 10, processing network 116 information, generating game outcomes, etc. The computer 20 is connected to the display screen 24 and controls content flow from the video source 110 via control signals provided in any suitable protocol, as described above. The purpose of the protocol is to provide a consistent communication protocol for all of the intelligent peripherals within the gaming station 10.

The video source 110 can be directly connected to the computer 20, as shown in FIG. 9, or can be connected across an electronic gaming network 14. The video source 110 and the video source 110 are described in greater detail below.

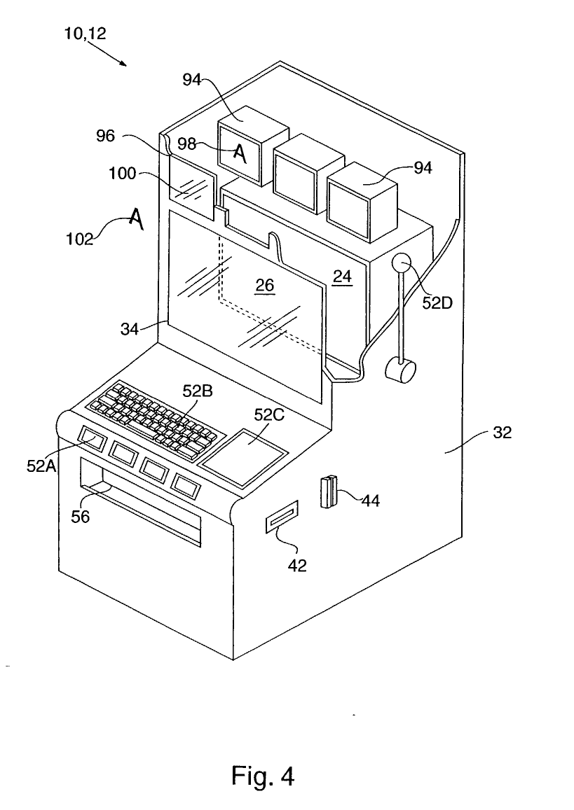

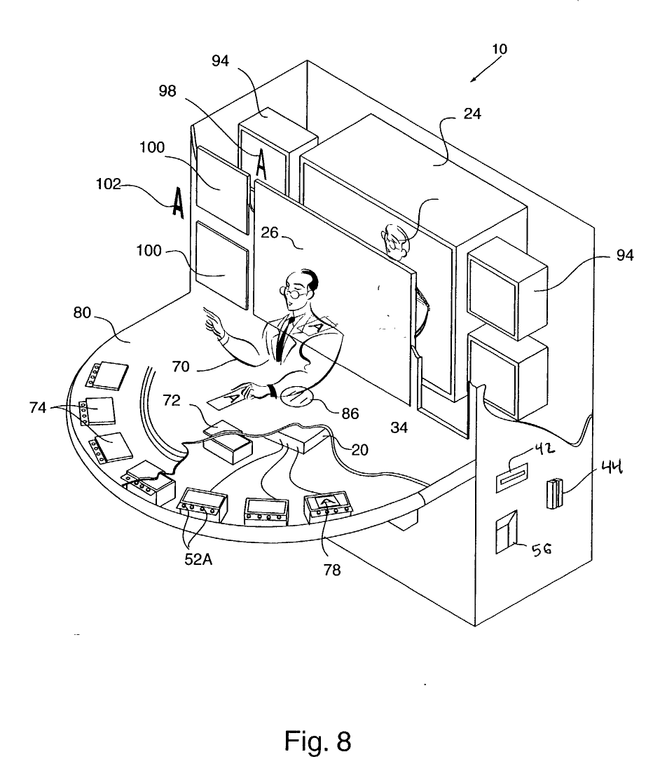

As shown in FIGS. 4-6 and 8, the display screen 24 is preferably a CRT display. However, it is possible to use other types of luminous displays such as LCD displays, plasma displays, field emission displays, digital micromirror displays, LCD touchscreens, etc. The display screen 24 includes or is operably attached to a video main graphics system (not shown). The video main graphics system functions to drive the display. In an alternative embodiment, wherein the electronic gaming station 10 does not include a display lens 26, the display screen 24 is set of spinning reels, and the computer 20 controls the display indirectly via a stepper motor (not shown).

The computer 20 includes a graphics controller (not shown) which provides data to the display screen 24. The graphics controller receives digital images and provides the pixel-by-pixel digital output to the displays. Preferably, graphics controller also provides some higher level functionality such as resizing graphical displays, etc. By providing such high level functionality, controller reduces the burden on other processors in the system. The graphics controller may be coupled to a video memory which temporarily stores a limited number of video images for rapid display on the displays. In one example, video memory stores about 16-32 megabytes of video data, although this can easily be increased with more expensive equipment and/or as storage technology advances.

Two embodiments of the gaming station 10 are as follows:

Slot Machine Embodiment

FIGS. 2-6 illustrate one embodiment of the invention in which the electronic gaming station 10 is adapted to function as an electronic slot machine 12.

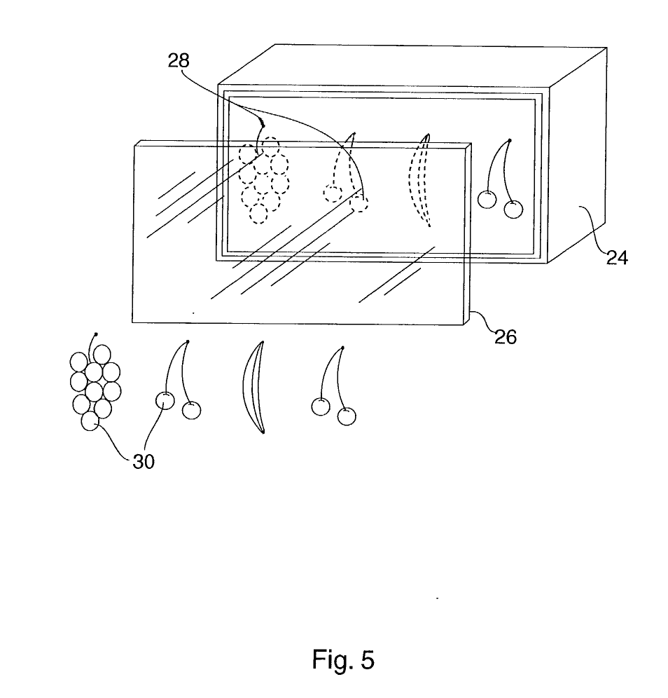

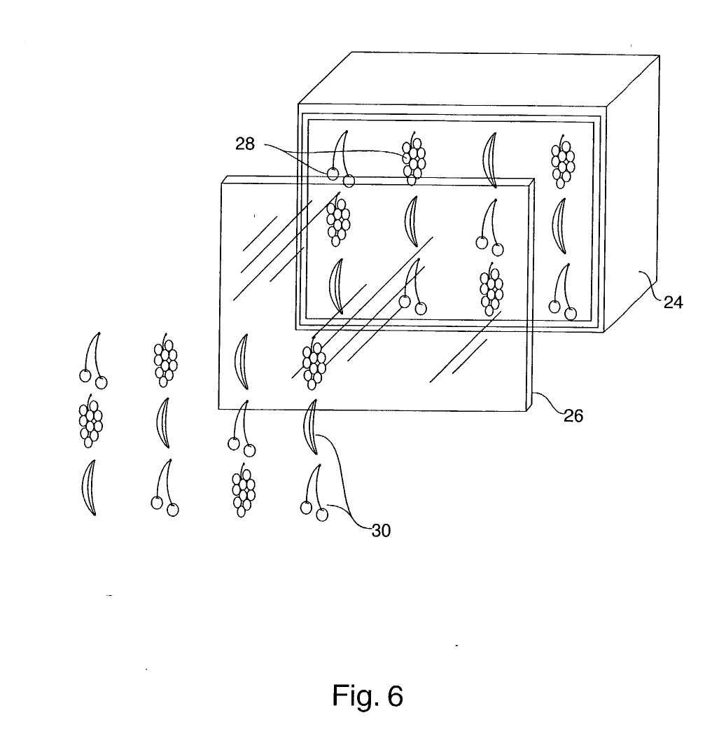

As shown in FIG. 2, in this embodiment the means for operating a game of chance 22 includes elements necessary for playing the slot machine 12. The computer 20 of the electronic slot machine 12 includes a means for generating 36 a plurality of pay line images 28 randomly from a library of pay line images 38. The electronic slot machine 12 displays the plurality of pay line images 28 on the display screen 24. The display lens 26 then functions to project a plurality of projected pay line images 30. In the preferred embodiment, the library of pay line images 38 are stored in digital form in a storage device 68 such as a hard drive of the computer 20. The plurality of pay line images 28 can be any images drawn from the prior art, including images of fruit, as shown in FIGS. 5 and 6, as well as images of dollar signs, bars, or other signs or symbols that are suitable for use with slot machines. Since the computer 20 can be built by one skilled in the art, and includes components that are well known in the art, it is not described in greater detail herein.

The means for generating 36 the plurality of pay line images 28 is preferably a software program that is stored on and executed by the computer 20. In one embodiment, the means for generating 36 randomly selects from the library at least three of the plurality of pay line images 28 according to probabilities that are provided by the software program. For example, each of the pay line images could have a 1% chance of being a jackpot bar, a 9% chance of being a cherry, a 10% chance of being a bell, a 10% chance of being a red bar, a 20% chance of being a green bar, and a 50% chance of being a lemon. Of course, those skilled in the art could devise many different arrangements of images, percentages, and other variables to make the game more entertaining, as long as the generation results in a game that fairly pays out legal returns. Selecting images randomly using the computer 20 can be a difficult challenge; however, we will not discuss the details of this technology herein, but defer to the experience of one skilled in the art to determine the best approach to assuring that the results are truly random.

As shown in FIGS. 5-6, the display screen 24 projects the plurality of pay line images 28 through the display lens 26. The display lens 26 is operably spaced apart from the display screen 24 to form the plurality of projected pay line images 28 beyond the display lens 26. As shown in FIG. 5, the plurality of pay line images 28 includes four pictures of fruit arranged horizontally. As shown in FIG. 6, the plurality of pay line images 28 includes three rows of four pictures of fruit, thereby providing additional rows of potentially winning combinations. In another embodiment (not shown), three rows of fruit can be used to create even further winning combinations, as is well known in the art. These and other alternatives that are known in the art should be considered within the scope of the present invention.

As shown in FIG. 2, the computer 20 further includes a library of winning combinations 39. Once the plurality of pay line images 28 has been randomly selected by the means for generating 36 the plurality of pay line images 28, the plurality of pay line images 28 is compared to the library of winning combinations 39 to determine whether the player wins any payment.

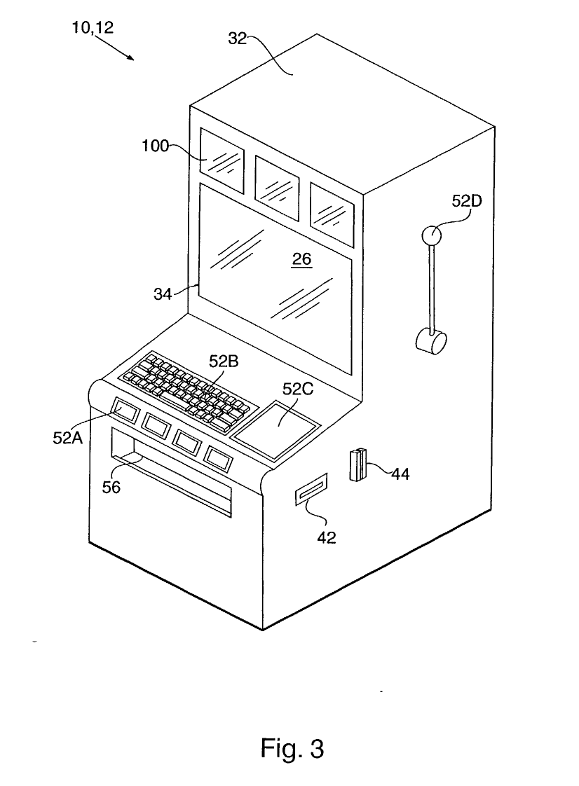

As shown in FIGS. 3 and 4, the electronic slot machine 12 is provided with a housing 32 for containing the computer 20 and the display screen 24. The housing 32 has a display aperture 34 through which the plurality of projected pay line images 30 are projected. The display lens 26 is mounted adjacent the display aperture 34, preferably within and entirely covering the display aperture 34, although various additional transparent layers, screens, or protective sheets (not shown) could also be added for various purposes, such as manipulating the plurality of projected pay line images 28 or protecting the display lens 26. Such additional elements could be devised by those skilled in the art and are therefore not described in the present invention.

As shown in FIGS. 2-4, the electronic slot machine 12 includes a means for receiving a payment 40 from the player to initiate play. The means for receiving a payment 40 could include any method currently used in the art of slot machines, including a coin slot (not shown), a credit card reader 44, a gaming card reader 42, described in greater detail below, or other similar devices known in the art.

The payment is tracked by the computer 20 and stored in a means for tracking credit 66, typically another function of the computer 20 performed by software that can be devised by one skilled in the art. In the preferred embodiment, the credit is tracked on a network 116 in a customer account 124 and/or a master customer account 126. This network 116 and its function is described in greater detail below.

As shown in FIGS. 2 and 3, once payment has been received, and credit has been stored in the computer 20, the player triggers the operation of the electronic slot machine 12 with a means for triggering 46 the computer 20 to generate the plurality of pay line images 28 once payment has been received. The means for triggering 46 can include any number of mechanisms known in the art, including a pull arm 52D, a plurality of control buttons 52A, or even voice command or similar control mechanism. While a pull arm 52D is preferably included, it is preferred that the plurality of control buttons 52A also be included to enable the player to control how various possible wagers are placed.

As shown in FIGS. 2 and 3, the electronic slot machine 12 further includes a means for dispensing payment 55 when the plurality of pay line images 28 that are selected from the library of pay line images 38 occur in the library of winning combinations 39. For example, if the plurality of pay line images 28 includes three or four of one type of fruit, such as cherries, a payment could be made. If the plurality of pay line images 28 includes four jackpot bars in a row, an enormous jackpot could be paid. Payment could be made by simply adding an amount to the means for tracking credit 66; or payment could be made by dispensing coins into the output coin dispenser 56.

In use, the player swipes his credit card through the credit card reader 44, inserts his or her gaming card 120 into the gaming card reader 42, or inserts one or more coins or tokens into the coin slot (not shown), or otherwise transfers money, chips, coupons, or other value to the electronic slot machine 12. The computer 20 tracks the payment and stored the payment as a credit in the means for tracking credit 66. The player then triggers the electronic slot machine 12 by pressing one of the control buttons 52A, typing on a keyboard 52B, using a touch-screen 52C, pulling the pull arm 52D, or otherwise triggering the means for triggering 46. The computer 20 then generates the plurality of pay line images 28 from the library of pay line images 38, and displays the plurality of pay line images 28 on the display screen 24. It is, of course, desirable to add special effects, such as making the plurality of pay line images 28 appear to randomly spin through possible outcomes to simulate a non-digital slot machine, and to also tantalize the player with near-misses of winning combinations.

As shown in FIGS. 5-6, the plurality of pay line images 28 are then projected through the display aperture 34 and the display lens 26 to create the plurality of projected pay line images 30. The plurality of projected pay line images 30 appear to float between the player and the electronic slot machine 12, creating a unique visual effect.

If the plurality of pay line images 28 (and thus the plurality of projected pay line images 30) occur in the library of winning combinations 39, the electronic slot machine 12 provides payment through the means for dispensing payment 55, such as crediting the means for tracking credit 66, although any mechanisms known in the art may be employed, such as a coin dispenser (not shown), or by printing a payment coupon that can be redeemed at a payment booth (not shown).

Blackjack Embodiment

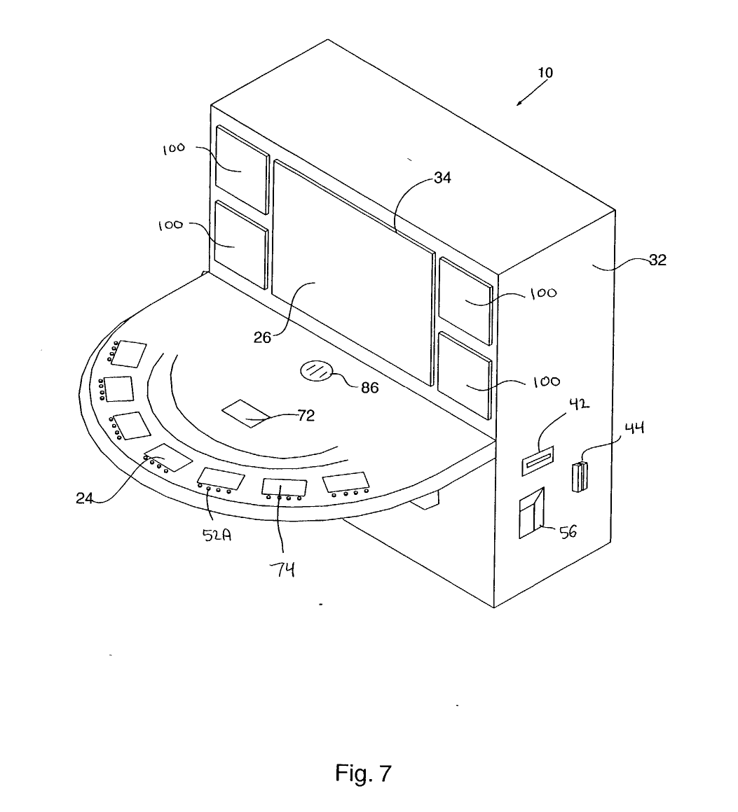

FIGS. 7-9 illustrate another embodiment of the invention in which the electronic gaming station 10 is adapted to play card games such as blackjack without requiring the presence of a human dealer. The gaming station 10 includes the display screen 24 and the display lens 26 described above. In this case, the display screen 24 is a dealer display screen adapted for providing a dealer image 69. As described above, the display lens 26 operably spaced apart from the dealer display screen 24 for projecting the dealer image 69 beyond the display lens 26 to form a projected dealer image 70.

As shown in FIG. 9, the means for operating a game of chance 22, in this embodiment, includes various elements for playing card games such as blackjack. This preferably includes a dealer card display screen 72 and a player card display screen 74. The computer 20 is operably connected to the dealer display screen 24, the dealer card display screen 72, and the player card display screen 74, so that the computer 20 can display card images 78 on the dealer card display screen 72 and the player card display screen 74 in coordination with the movements of the projected dealer image 70. The housing 32, as described above, contains the computer 20 and the dealer display screen 24. The housing 32 further includes a table portion 80 extending from the housing 32 which functions to operably support the dealer card display screen 72 and the player card display screen 74 in a position that can be easily viewed by a player of the game.

As described above, the dealer display screen 24 is used for forming the dealer image 69. The dealer display screen 24 is preferably a CRT computer monitor, although other luminous screens such as LCD screens and the like can also be used. The dealer display screen 24 is positioned behind the display lens 26, which is operably spaced apart from the dealer display screen 24 for projecting the dealer image 69 beyond the display lens 26 to form a projected dealer image 70. The dealer image 69 is generated from the video source 110, described below, that is operably connected to the computer 20, either directly of through the network 116.

The dealer card display screen 72 and the player card display screen 74 are preferably small flat panel LCD display screens, although other similar devices can be used. The computer 20 is operably connected to the dealer card display screen 72 and the player card display screen 74 so that the computer 20 can generate random cards for the purposes of playing a card game. While blackjack is described in the present embodiment, those skilled in the art will recognize that the gaming station 10 can be adapted that any card game can be simulated, including but not limited to poker or any other card game well known in the art of gambling.

The computer 20 further includes a means for generating card images 76. The means for generating card images 76 can be provided with software that can be devised by one skilled in the art of computer 20 programming once the programmer has been advised of the present invention. The software would select randomly from a variety of playing cards according to statistics and procedures that are determined to simulate real card play. The cards would preferably be generated and displayed on the dealer card display screen 72 and the player card display screen 74 in coordination with the movements of the projected dealer image 70.

For example, the projected dealer image 70 would appear to move like a real dealer throwing a card towards the player. Simultaneously, the player card display screen 74 would display the randomly selected card image 78 selected by and generated by the computer. The projected dealer image 70 would then make a motion apparently throwing a card in front of the projected dealer image 70, and another randomly selected card image would appear in the dealer card display screen 72. This process would continue until all of the cards have been dealt to all of the players. Depending upon the game, additional cards could be added, such as “throwing away” cards in poker so that new cards could be dealt, or by requesting “hits” in blackjack.

In addition to controlling the images shown in the various screens, the computer 20 also functions to control the operation of the gaming station 10, although this function could also be controlled by a second computer (not shown). The term computer 20 is specifically defined as any computational mechanism, or mechanisms in combination, that compute, especially a programmable electronic machine that performs high-speed mathematical or logical operations or that assembles, stores, correlates, or otherwise processes information, alone or in combination with one or more other computational mechanisms, whether entirely within the housing 32 or otherwise operably connected or networked therewith.

The computer 20 includes the means for operating a game of chance 22, described above, but adapted for the present embodiment. In this embodiment, the means for operating a game of chance 22 includes a means for controlling 84 the operation of the gaming station 10, a means for placing and collecting wagers 90, a means for tracking and adjusting 92 the credit balances stored on the computer 20, and other functionality desired by the game designer.

The means for controlling 84 includes functions for initiating play and for operably controlling the progress of the game. In one embodiment, the gaming station 10 includes a microphone 86 and the computer 20 includes voice recognition software 88 so that the player could initiate play be verbally asking the dealer to deal a hand. The microphone 86 also enables the player to place initial bets, ask for a hit, ask to discard certain cards, double down, or perform any other function of a dealer. While the present embodiment of the gaming station 10 includes voice recognition technology that enables the player to control the computer 20 by voice, other alternative mechanisms are also suitable, including the control buttons 52A, the keyboard 52B or the touch screen, as described above. Those skilled in the art can devise suitable control mechanisms using the teachings of the present invention, and such control mechanisms should be considered within the scope of the present invention.

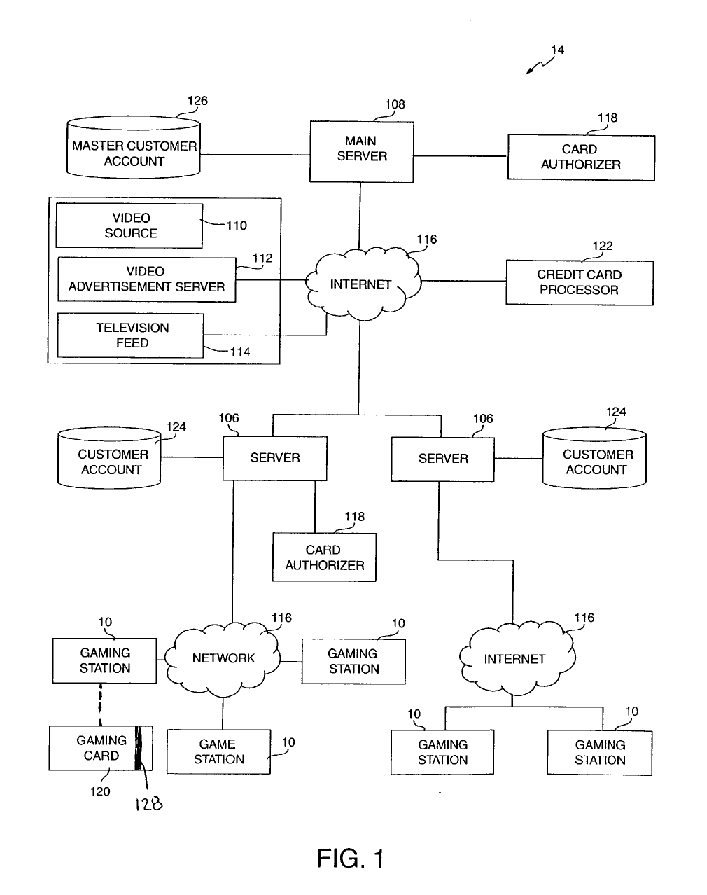

As shown in FIGS. 1 and 9, the means for placing and collecting wagers 90 is similar to the system described above in the first embodiment, preferably including the credit card reader 44, the gaming card reader 42, and/or by otherwise reading money or chips inserted into the gaming station 10 or provided on credit. The means for placing and collecting wagers 90 includes software for reading and authorizing the payment, and then for transmitting the proper debits and credits for tracking both by the computer 20 and any outside computers, such as the credit card processor 122. The computer 20 includes a means for tracking and adjusting 92 the credit balance stored on the computer 20 as appropriate during the course of the game. This can be accomplished using appropriate software installed on the computer, or across the network 116 in conjunction with a customer account 124 and/or master customer account 126 of a server 106, as described below. Finally, the computer 20 software of the means for placing and collecting wagers 90 includes a mechanism for paying out the credit amount at the end of play, crediting and debiting the various accounts, as needed. This can also include ejecting coins into an output coin dispenser 56, printing a receipt redeemable at a central processing location (not shown), crediting the customer account 124, or otherwise making payment as known in the art.

Advertising Display Screen

The electronic gaming station 10 preferably further includes an advertising display screen 94 for providing an advertisement image 98, and an advertisement lens 100 operably spaced apart from the advertising display screen 94 for projecting the advertisement image 98 beyond the advertisement lens 100 to form a projected advertisement image 102. The advertising display screen 94 is operatively connected for receiving the advertisement image 98 from the video source 110, preferably through the computer 20.

The storage device 68, such as a hard drive and/or PCMCIA cards, may be employed to hold in digital form the advertisement images 98 that are frequently displayed on the advertising display screen 94, as well as associated sound. The housing 32 of the electronic gaming station 10 also includes an advertisement aperture 96 across which is mounted the advertisement lens 10 and through which the projected advertisement image 102 is projected to form the projected advertisement image 102.

The Display and the Advertisement Lens

The display lens 26 and the advertisement lens 100 are both lenses adapted for forming projected images. In the preferred embodiment, the lenses are Fresnel lenses similar to the lens used in Machtig et al., U.S. Pat. No. 5,782,547, hereby incorporated in full by reference. The specific construction of the lenses will vary according to the desired specifications of each projected image. In one embodiment, the lenses are each plano-convex fresnel lenses having a focal length of 18 inches, a 143 groove structure, a diameter of 18.5 inches, and having a thickness of 0.11 inches. In this embodiment, the lenses are preferably manufactured as Part Number 48.4 by Fresnel Technologies, Inc., at 101 West Morning Drive, Fort Worth, Tex., 76110. When using the preferred lenses having a focal length of 18 inches, the projected images appear to be created 18 inches in front of the lenses. In another embodiment, the lenses are manufactured by RHK Japan, Inc., located at 2-99-217 Jingumae 2-chome, Shibuya-ku, Tokyo 150, Japan.

The terms “display lens” 26 and “advertisement lens” 100 are intended to specifically encompass (1) the Fresnel-type lenses described above, (2) any type of lens that performs this function, whether or not it is a Fresnel lens, and (3) any combination of multiple lenses that function to project an image in the fashion described. Obviously, it would be impossibly complex and confusing to attempt to find language to describe and claim all of these combinations; however, by correctly using our definition of these terms, the claimed invention should include the variations described above. Examples of combinations known in the art and therefore within the scope of the present definition are described above and also incorporated by reference.

Electronic Gaming Network

In the embodiment shown in FIG. 1, the electronic gaming station 10 is preferably used as part of an electronic gaming network 14 that includes a network 116 such as the Internet, or a local area network. The network 116 can include a server 106 such as a casino server to service a casino location, a regional server to service a regional location, and/or a main server 108 for tying together many of the gaming stations 10, several networks 116 of the gaming stations 10, and also incorporating outside links, such as to the video source 110 as described below, to a credit card processor 122, and other services related to the gaming stations 10.

Video Source

In one embodiment, as shown in FIGS. 1, 2 and 9, the electronic gaming station 10 includes a modem 104 operably attached to the computer 20, and the computer 20 is operably connected to the advertising display screen 94 for transmitting the advertisement images 98 from the network 14 through the modem to the advertising display screen 94. In this embodiment, the modem 104 is operably connectable to the server 106 which is operably connected with the video source 110, thereby enabling the computer 20 to access the video source 110 through the modem 104 and download the advertisement images 98. The video source 110 is preferably a video advertisement server 112 that streams the advertisement images 98 as determined by the main server 108. In this embodiment, the video source 110 also includes a television feed 114 from a cable network 116, a satellite network 116, or similar source. The advertisement images 98 are preferably specially formatted to remove background light and images and thereby produce a clean and distinct projected advertisement image 102.

It is worth noting that while the server 106 and the video advertisement server 112 are listed as two separate elements, it is not required that these be physically located on different machines using different processors. It is contemplated that many of the various computer functions described throughout this disclosure could be performed on the same computer processor, use common memory, etc.

In another embodiment, as shown in FIG. 9, the computer 20 is directly attached to a video source 110, such as a videocassette recorder (VCR) or a DVD player (not shown). In this embodiment, the advertisement images 98 are pre-recorded on the appropriate media and played in an endless loop. The media can be changed periodically as required to update the advertising images. Alternatively, the advertisement images 98 could be stored in digital form on the storage device 68.

To facilitate the function of the computer 20, a multimedia board (not shown) can accept multiple video inputs from a network 116 or other sources. As shown, the inputs to multimedia board possibly include NTSC signals from the VCR-type sources and RF video signals from cable television-type sources. Examples of such inputs include casino kiosk information, television broadcasting, etc. Various inputs are available from the computer. These include video signals, audio signals, and address, data, and control signals. Each of these inputs may be provided over a local bus. The output of multimedia board includes digital video signals to the display screen 24, the advertisement display screen 94, and to the graphics controller.

RF video programming provided to multimedia board is first processed by a television tuner (not shown). The tuner separates the audio and video signal content from the RF input signal. The video signal is directed to an NTSC/PAL decoder (not shown) which decodes encoded video data in accordance with industry standards. Decoded video data can be provided to a video processor (not shown) which mixes video signals from various sources including the digital video. The mixed video signals are then directed to a digital analog converter (not shown) which outputs an analog video signal to display screen 24 and to the advertisement display screen 94. Video signals from NTSC sources are input directly to the decoder. Otherwise, they are treated identically to the video portion of the RF input signal. Video signals for the advertising display are output directly from the decoder and directed to the graphics controller for further processing. Since such electronics construction and programming is well known to those skilled in the art, it is not described in greater detail herein.

The television programming may be provided to the gaming station 10 via cable link, satellite, or other suitable connection. All or some of the programming provided by a television broadcaster may be displayed as content on the advertisement display screen 94. In the alternative, the programming could be provided in-house, or via a local area network 116 that encompasses a region, casino, or group of casinos. Content of particular interest to casino operators includes, for example, sporting events, talk shows, game shows, comedies, and competitive events on which the player can wager may be displayed. For example, dog racing or horse racing events may be displayed as content. When the race or other competition begins, the player can focus his or her attention on that event without needing to leave the gaming station 10. Similarly, the video content can include information available on the Internet, or the gaming station 10 can be used to enable the player to download his or her email.

Another use of the advertisement display screen 94 is to provide two-way communication between the player and a casino attendant or other individual, to host slot tournaments, keno games, and to show videos of other players winning jackpots. The above-stated examples provided above are illustrative of the present invention; however, the scope of the claimed invention should be construed to include all equivalent structures and methods of execution.

Gaming Card

In the embodiment shown in FIGS. 1-4 and 7-9, a gaming card reader 42 is operably attached to the electronic gaming station 10 and a card authorizer 118 is operably attached to the server 106. The gaming card reader 42 is adapted to read a gaming card 120 that has been authorized by the card authorizer 118 and thereby retrieve information about the player that has been stored in a customer account 124 accessible by the server 106.

The gaming card reader 42 can include a separate processor for handling player tracking information, or can be operably attached to the computer 20 of each gaming station 10. The gaming card reader 42 includes a magnetic strip reader, an optical scanner, or similar reader capability to enable the gaming card reader 42 to receive information from the gaming card 120. The gaming card reader 42 communicates with the players of the gaming station 10 via an interface that can be included on the display screen 24, the advertising display screen 94, or a separate card reader LCD (not shown). Interaction can be facilitated with the keyboard 52B, the touch-screen 52C, or any other similar devices.

The gaming card reader 42 is adapted to be used with gaming cards 120 or similar player tracking cards issued by casinos or other entities. The gaming card reader 42 may also read credit or debit cards for accessing a player's remote financial account directly, or the gaming station 10 can include a separate credit card reader 44. In this regard, keyboard 52B may be employed to key in account information allowing electronic funds transfer between gaming station 10 and a credit card processor 122 or other remote financial institution. Gaming stations 10 which allow access to remote financial institutions via credit or debit cards are described in the prior art previously incorporated by reference. It should be noted that insertion of a gaming card 120 may alert the main server 108 that a particular customer is playing. In response, the main server 108 can direct particular advertisement images 98 or other messages to that particular gaming station 10.

The gaming card reader 42 enables the entire gaming network 14 to be used to track the playing habits of all of the players who use the system. This facilitates the award of various awards or incentives to encourage hotel and casino loyalty.

Hotel Embodiment

In one embodiment, the gaming card 120 authorized by the card authorizer 118 further includes a means for unlocking a door. The means for unlocking can include an identification strip 128 that is adapted to by read by an electronic door lock scanner (not shown). The term identification strip 128, as used in the application, is intended to encompass several equivalent technologies, including magnetic strips, computer chips embedded in the gaming card 120, bar codes, and equivalent identification technologies.

In this embodiment, the player receives a gaming card 120 when he or she checks into a hotel of the casino. The player is able to establish an account at this time (if he or she does not already have one). The player is able to deposit money into this account, link the account to a credit card or line of credit, or otherwise establish funds for use in gambling. The player carries the gaming card 120 for purposes of getting into the hotel room. The player simply inserts the gaming card 120 into a reader (not shown) of his or her hotel room door and the identification strip 128 triggers the locking mechanism of the door to admit the player to his or her room.

The player is also able to insert the gaming card 120 into the gaming card reader 42 of any of the gaming stations 10, and the identification strip 128 functions to give the player access to his account of gambling funds, thereby enabling the player to gamble without the need to purchase chips, provide a credit card, or otherwise provide payment. Information about the player, entered at check in, enables the casino to track the player, his or her gambling habits, or any other information that the casino or other party might want to track.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An electronic gaming station with 3D advertising, the electronic gaming station comprising:
a game display screen;
a computer having a means for operating a game of chance, the computer being operably connected to the game display screen for displaying output images of the game of chance;
an advertising display screen for providing an advertisement image;
an advertisement lens operably spaced apart from the advertising display screen for projecting the advertisement image beyond the advertisement lens to form a projected advertisement image;
the advertising display screen also being operatively connected for receiving the advertisement image from a video source; and
a housing for containing the computer, the housing having an aperture across which is mounted the advertisement lens and through which the projected advertisement image is projected.

2. The electronic gaming station of claim 1 further comprising a modem operably attached to the computer, the computer being operably connected to the advertising display screen, the modem being adapted to be operably connectable to a server that is operably attached to the video source.

3. The electronic gaming station of claim 2 further comprising a gaming card reader operably attached to the electronic gaming station and a card authorizer operably attached to the server.

4. The electronic gaming station of claim 3 wherein the gaming card reader is adapted to read a gaming card that has been authorized by the card authorizer and thereby retrieve information about the customer that has been stored in a customer account accessible by the server.

5. The electronic gaming station of claim 4 wherein a gaming card authorized by the card authorizer further includes a means for unlocking an electronic door.

6. The electronic gaming station of claim 5 wherein the means for unlocking includes an identification strip that is adapted to by read by an electronic door lock scanner.

7. The electronic gaming station of claim 1 further comprising a display lens mounted across a display aperture of the housing and operably spaced in front of the display screen for projecting the output images of the game of chance to form projected output images in front of the gaming station.

8. An electronic gaming station for playing card games, the electronic gaming station comprising:
a dealer display screen for providing a dealer image;
a display lens operably spaced apart from the dealer display screen for projecting the dealer image beyond the display lens to form a projected dealer image;
a dealer card display screen;
a player card display screen;
a computer operably connected to the dealer display screen, the dealer card display screen and the player card display screen, the computer having a means for displaying card images on the dealer card display screen and the player card display screen in coordination with the movements of the projected dealer image;
a housing for containing the computer and the dealer display screen, the housing having an aperture through which the projected dealer image is projected; and
a table portion extending from the housing, the table portion operably supporting the dealer card display screen and the player card display screen.

9. An electronic slot machine comprising:
a computer having a means for generating a plurality of pay line images randomly from a library of pay line images,
a display screen operably connected to the computer for displaying the plurality of pay line images;
a display lens operably spaced apart from the display screen for projecting the plurality of pay line images beyond the display lens to form a plurality of projected pay line images;
a housing for containing the computer and the display screen, the housing having an aperture through which the plurality of projected pay line images are projected;
a means for receiving a payment;
a means for triggering the computer to generate the plurality of pay line images once payment has been received; and
a means for dispensing payment when the plurality of pay line images that are selected from the library occur in one of a plurality of winning combinations.

10. An electronic gaming network comprising:
a plurality of electronic gaming stations having a game display screen, a computer having a means for operating a game of chance, the computer being operably connected to the game display screen for displaying output images of the game of chance;
a server operably connected to each of the plurality of electronic gaming stations;
a gaming card reader operably attached to each of the plurality of electronic gaming stations; and
a card authorizer operably attached to the server for issuing a plurality of gaming cards, each of the gaming cards having a means for unlocking a door.

11. The electronic gaming network of claim 10 further comprising:
an advertising display screen for providing an advertisement image;
an advertisement lens operably spaced apart from the advertising display screen for projecting the advertisement image beyond the advertisement lens to form a projected advertisement image;
the advertising display screen also being operatively connected for receiving the advertisement image from a video source; and
a housing for containing the computer, the housing having an aperture across which is mounted the advertisement lens and through which the projected advertisement image is projected.
